(19) United States
(12) Patent Application Publication
(10) Pub. No.: US 2024/0308908 A1
(43) Pub. Date: Sep. 19, 2024

(54) Gypsum Panel Containing a Magnetic Additive

(71) Applicant: Gold Bond Building Products, LLC, Charlotte, NC (US)

(72) Inventors: Bradley J. Busche, Shelby, NC (US); Joseph J. Bailey, Charlotte, NC (US); Ratnasabapathy Gurunathan Iyer, Charlotte, NC (US); Richard P. Weir, Indian Trail, NC (US)

(21) Appl. No.: 18/604,857

(22) Filed: Mar. 14, 2024

Related U.S. Application Data
(60) Provisional application No. 63/490,347, filed on Mar. 15, 2023.

(51) Int. Cl. C04B 14/30; B32B 5/02; B32B 13/02; B32B 13/04; B32B 13/14; B32B 37/00; B32B 37/24; C04B 28/14; C04B 40/00; C04B 111/00; E04C 2/28

(52) U.S. Cl. CPC C04B 14/308; B32B 5/02; B32B 13/02; B32B 13/04; B32B 13/14; B32B 37/0046; B32B 37/24; C04B 28/14; C04B 40/0007; E04C 2/28; B32B 2250/40; B32B 2262/101; B32B 2264/102; B32B 2264/303; B32B 2264/502; B32B 2307/208; B32B 2310/0806; B32B 2315/00; B32B 2607/00; C04B 2111/00629

(57) ABSTRACT

The present invention is directed to a gypsum panel and a method of making such gypsum panel. For instance, in one embodiment, the gypsum panel comprises a gypsum core and a first facing material and a second facing material sandwiching the gypsum core, wherein the gypsum core includes gypsum and one or more magnetic additives. The methods of the present invention are directed to making the aforementioned gypsum panels by providing the first facing material, providing a gypsum slurry comprising gypsum, water, and one or more magnetic additives onto the first facing material, and providing a second facing material on the gypsum slurry.

### RELATED APPLICATIONS

The present application is based on and claims priority to U.S. Provisional Patent Application Ser. No. 63/490,347, filed on Mar. 15, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum, water, and other conventional additives. The mixture is cast and allowed to set by reaction of the calcined gypsum with the water. Traditionally, when gypsum panels are utilized in exterior sheathing applications, an air and water barrier (“AWB”) sealant, layer, or coating is utilized to mitigate or prevent water intrusions. Notably, the prevention or mitigation of water intrusions into the exterior gypsum sheathing supports the longevity of both the gypsum sheathing and the structure to which the gypsum sheathing is affixed. However, applying an air and water barrier sealant to gypsum sheathing generally requires a considerable amount of labor, is generally subject to human error during application, and may even provide insufficient air and water resistance.

As a result, there is a need to provide an improved gypsum panel that provides air and water resistance.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises: a gypsum core comprising gypsum and one or more magnetic additives and having a concentration gradient of the one or more magnetic additives over a thickness of the gypsum core; and a first facing material and a second facing material, the first facing material and the second facing material sandwiching the gypsum core.

In accordance with one embodiment of the present invention, a gypsum panel is disclosed. The gypsum panel comprises: a gypsum core comprising gypsum and one or more magnetic additives; and a first facing material and a second facing material, the first facing material and the second facing material sandwiching the gypsum core, wherein at least a portion of the one or more magnetic additives penetrates a thickness of the first facing material, the second facing material, or both.

In accordance with another embodiment of the present invention, a method of making a gypsum panel is disclosed. The method comprises: providing a first facing material; depositing a gypsum slurry comprising stucco, water, and one or more magnetic additives onto the first facing material; providing a second facing material on the gypsum slurry; and allowing the stucco to convert to calcium sulfate dihydrate, wherein the method further comprises generating at least one magnetic field with one or more magnets before providing the second facing material on the gypsum slurry and/or after the step of providing the second facing material on the gypsum slurry, the at least one magnetic field moving at least a portion of the one or more magnetic additives in the gypsum slurry toward the first facing material, the second facing material, or both.

In accordance with another embodiment of the present invention, a system of forming a gypsum panel containing one or more magnetic additives is disclosed. The system comprises: one or more magnets for generating one or more magnetic fields; a conveyor assembly; and a gypsum slurry, the gypsum slurry comprising one or more magnetic additives.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of one embodiment of a system for forming a gypsum panel containing one or more magnetic additives in accordance with aspects of the present subject matter; and

FIG. 2 illustrates a schematic view of another embodiment of a system for forming a gypsum panel containing one or more magnetic additives in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method and system of making such gypsum panel. In particular, the gypsum panel can include a gypsum core including one or more magnetic additives as defined herein. In this regard, the gypsum core can include gypsum (i.e., calcium sulfate dihydrate), one or more magnetic additives, and may include other optional additives. The present inventors have discovered that the gypsum panel disclosed herein can have various benefits due to the use of one or more magnetic additives. Notably, the present inventors have discovered that the mechanical properties and characteristics of the gypsum panel may be improved. For instance, the gypsum panel disclosed herein may have increased wet bond, dry bond, air resistance, and/or water resistance. In general, the one or more magnetic additives may reduce, mitigate, and/or prevent the intrusion of air and/or water into the gypsum panel and/or the structure behind the gypsum panel, such as wood studs.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In general, the gypsum core may comprise calcium sulfate dihydrate. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In one aspect, the gypsum core may comprise one or more magnetic additives. Generally, the one or more magnetic additives may include a ferrimagnetic additive. The ferrimagnetic additive may comprise a soft ferrite (e.g., manganese-zinc ferrite, nickel-zinc ferrite), a hard ferrite (e.g., barium ferrite, strontium ferrite), or a combination thereof. In general, a magnetic additive of the one or more magnetic additives may comprise aluminum, barium, cobalt, copper, dysprosium, gadolinium, erbium, holmium, iron, magnesium, nickel, strontium, zinc, or a combination or alloy thereof. In some aspects, the one or more magnetic additives may comprise an aluminum nickel cobalt alloy (i.e., an alnico), an aluminum iron alloy, a cobalt iron alloy, a copper iron alloy, a copper nickel alloy, a hematite, iron carbide, a magnesium iron alloy, a magnetite (e.g., MagniF 10, MagniF 25, MagniF 50), manganese dioxide, a nickel iron alloy (e.g., Permalloy®, awaruite), a nickel copper iron alloy, or a combination thereof. Additionally, for instance, the one or more magnetic additives may comprise ferromagnetic ceramics (e.g., nickel ferrite ceramic, zinc ferrite ceramic). It should be understood that the one or magnetic additives disclosed herein may comprise other suitable magnetic additives alternatively or in addition to the additives and components disclosed herein.

In general, the one or more magnetic additives may have a selectively chosen average particle size. For instance, the one or more magnetic additives may have an average particle size of 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less. The one or more magnetic additives may have an average particle size of 100 nanometers or more, such as 250 nanometers or more, such as 500 nanometers or more, such as 750 nanometers or more, such as 1 micron or more, such as 5 microns or more, such as 10 microns or more, such as 15 microns or more, such as 20 microns or more, such as 25 microns or more, such as 40 microns or more, such as 50 microns or more, such as 75 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more. Furthermore, in one aspect, the aforementioned values may refer to a median particle size of the one or more magnetic additives. In this respect, the one or more magnetic additives may have a D10, D50, or D98 Of any of the values or ranges of values previously disclosed, including any incremental values therebetween.

The one or more magnetic additives may have a selectively chosen particle size distribution. The particle size distribution of the one or more magnetic additives may be monomodal, bi-modal, or multi-modal. The one or more modes may fall within any of the particle size values, including any ranges thereof, disclosed herein. In one aspect, a mesh size of 20 microns may retain from about 20 wt. % to about 100 wt. % of the one or more magnetic additives, including all increments of 0.01 wt. % therebetween. For instance, a mesh size of 20 microns may retain about 20 wt. % or more, such as about 40 wt. % or more, such as about 60 wt. % or more, such as about 80 wt. % or more, such as about 100 wt. % or less, such as about 80 wt. % or less, such as about 60 wt. % or less, such as about 40 wt. % or less of the one or more magnetic additives. In one aspect, a mesh size of 45 microns may retain from about 0 wt. % to about 90 wt. % of the one or more magnetic additives, including all increments of 0.01 wt. % therebetween. For instance, a mesh size of 45 microns may retain about 0 wt. % or more, such as about 20 wt. % or more, such as about 40 wt. % or more, such as about 60 wt. % or more, such as about 90 wt. % or less, such as about 60 wt. % or less, such as about 40 wt. % or less, such as about 20 wt. % or less of the one or more magnetic additives. In one aspect, a mesh size of 125 microns may retain from about 0 wt. % to about 50 wt. % of the one or more magnetic additives, including all increments of 0.01 wt. % therebetween. For instance, a mesh size of 125 microns may retain about 0 wt. % or more, such as about 10 wt. % or more, such as about 20 wt. % or more, such as about 30 wt. % or more, such as about 40 wt. % or more, such as about 50 wt. % or less, such as about 40 wt. % or less, such as about 30 wt. % or less, such as about 20 wt. % or less, such as about 10 wt. % or less of the one or more magnetic additives.

In one aspect, the one or more magnetic additives may have a selectively chosen content of iron oxide. For instance, the one or more magnetic additives may have an iron oxide content of about 80 wt. % to about 100 wt. %, including all increments of 1 wt. % therebetween. For instance, the one or more magnetic additives may have an iron oxide content of about 80 wt. % or more, such as about 85 wt. % or more, such as about 90 wt. % or more, such as about 92 wt. % or more, such as about 95 wt. % or more, such as about 97 wt. % or more, such as about 98 wt. % or more, such as about 99 wt. % or more. In general, the one or more magnetic additives may have an iron oxide content of about 100 wt. % or less, such as about 99 wt. % or less, such as about 98 wt. % or less, such as about 97 wt. % or less, such as about 95 wt. % or less, such as about 92 wt. % or less, such as about 90 wt. % or less, such as about 85 wt. % or less.

In general, the one or more magnetic additives may have a bulk density of about 1200 kg/m³ to about 2500 kg/m3, such as about 1200 kg/m³ or more, such as about 1300 kg/m³ or more, such as about 1400 kg/m³ or more, such as about 1500 kg/m³ or more, such as about 1600 kg/m³ or more, such as about 1700 kg/m³ or more, such as about 1800 kg/m³ or more, such as about 1900 kg/m³ or more, such as about 2000 kg/m³ or more, such as about 2100 kg/m³ or more, such as about 2200 kg/m³ or more, such as about 2300 kg/m³ or more, such as about 2400 kg/m³ or more. Generally, the one or more magnetic additives may have a bulk density of about 2500 kg/m³ or less, such as about 2400 kg/m³ or less, such as about 2300 kg/m³ or less, such as about 2200 kg/m³ or less, such as about 2100 kg/m³ or less, such as about 2000 kg/m³ or less, such as about 1900 kg/m³ or less, such as about 1800 kg/m³ or less, such as about 1700 kg/m³ or less, such as about 1600 kg/m³ or less, such as about 1500 kg/m³ or less, such as about 1400 kg/m³ or less, such as about 1300 kg/m³ or less.

Generally, the one or more magnetic additives may have a solid density of about 4500 kg/m³ to about 6000 kg/m3, such as about 4500 kg/m³ or more, such as about 4600 kg/m³ or more, such as about 4800 kg/m³ or more, such as about 5000 kg/m³ or more, such as about 5200 kg/m³ or more, such as about 5400 kg/m³ or more, such as about 5600 kg/m³ or more, such as about 5800 kg/m³ or more. In general, the one or more magnetic additives may have a solid density of about 6000 kg/m³ or less, such as about 5800 kg/m³ or less, such as about 5600 kg/m³ or less, such as about 5400 kg/m³ or less, such as about 5200 kg/m³ or less, such as about 5000 kg/m³ or less, such as about 4800 kg/m³ or less.

In general, a gypsum panel formed in accordance with the present disclosure may have an enhanced wet bond and/or dry bond compared to a traditional gypsum panel. As used herein, “wet bond” refers to the embedment and attachment of the gypsum slurry in and to a respective facing material before the gypsum panel is dried in a kiln or oven. The wet bond is determined by weighing a facing material before the facing material comes into contact with a gypsum slurry, contacting the facing material with the gypsum slurry, allowing the gypsum slurry to set, removing the facing material from the gypsum core, and then weighing the facing material. The larger the difference between the two respective weights of the facing material, the higher the value of the wet bond. As used herein, the wet bond is calculated by the percent increase in facing material weight. Notably, the second measurement of the facing material weight is generally larger than the first measurement of the facing material weight because a portion of the gypsum slurry or gypsum core components (e.g., gypsum, water) remain adjacent to, in contact with, and/or embedded in the facing material. Generally, an enhanced wet bond may be advantageous in a gypsum panel because an enhanced wet bond generally corresponds to an enhanced gypsum core to facing material bond. As used herein, “dry bond” refers to the embedment and attachment of the gypsum slurry in and to a respective facing material after the gypsum panel is dried in a kiln or oven. The dry bond is determined by weighing a facing material before the facing material comes into contact with a gypsum slurry, contacting the facing material with the gypsum slurry, allowing the gypsum slurry to set, drying the gypsum core and respective facing materials in a kiln or oven, removing the facing material from the gypsum core, and then weighing the facing material. The larger the difference between the two respective weights of the facing material, the higher the value of the dry bond. As used herein, the dry bond is calculated by the percent increase in facing material weight. Notably, the second measurement of the facing material weight is generally larger than the first measurement of the facing material weight because a portion of the gypsum slurry or gypsum core components (e.g., gypsum, water) remain adjacent to, in contact with, and/or embedded in the facing material. Generally, an enhanced dry bond may be advantageous in a gypsum panel because an enhanced dry bond generally corresponds to an enhanced gypsum core to facing material bond.

In one aspect, when compared to a gypsum panel with no magnetic additives, the one or more magnetic additives may increase the wet bond and/or dry bond of a gypsum panel by about 5% or more, such as about 10% or more, such as about 20% or more, such as about 30% or more, such as about 40% or more, such as about 50% or more, such as about 60% or more, such as about 70% or more, such as about 80% or more, such as about 90% or more. In general, when compared to a gypsum panel with no magnetic additives, the one or more magnetic additives may increase the wet bond and/or dry bond of a gypsum panel by about 100% or less, such as about 90% or less, such as about 80% or less, such as about 70% or less, such as about 60% or less, such as about 50% or less, such as about 40% or less, such as about 30% or less, such as about 20% or less, such as about 10% or less. Notably, in one aspect, when compared to a gypsum panel with no magnetic additives, the one or more magnetic additives may increase the wet bond and/or dry bond of a gypsum panel by about 100% or more.

Generally, one or more magnetic additives may be present in any element of the disclosed gypsum panel. For instance, one or more magnetic additives may be present in one or more of the facing materials (e.g., first facing material, second facing material) of the gypsum panel. Additionally or alternatively, for instance, one or more magnetic additives may be present in the gypsum slurry or the gypsum core of the gypsum panel. Further, for instance, one or more magnetic additives may be present in one or more gypsum core layers of the gypsum panel.

The one or more magnetic additives may be present in the gypsum panel in an amount of 0.001 lbs/MSF to 100 lbs/MSF, including all increments of 0.001 lbs/MSF therebetween. For instance, the one or more magnetic additives may be present in the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 15 lbs/MSF or more, such as 20 lbs/MSF or more, such as 30 lbs/MSF or more, such as 40 lbs/MSF or more, such as 50 lbs/MSF or more, such as 60 lbs/MSF or more, such as 70 lbs/MSF or more, such as 80 lbs/MSF or more, such as 90 lbs/MSF or more. Generally, the one or more magnetic additives may be present in the gypsum panel in an amount of 100 lbs/MSF or less, such as 90 lbs/MSF or less, such as 80 lbs/MSF or less, such as 70 lbs/MSF or less, such as 60 lbs/MSF or less, such as 50 lbs/MSF or less, such as 40 lbs/MSF or less, such as 30 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Notably, the one or more magnetic additives may be present in the gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more. Generally, the one or more magnetic additives may be present in the gypsum panel and/or any component thereof in an amount of 15 wt. % or less, such as 12 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1 wt. % or less, such as 0.8 wt. % or less, such as 0.6 wt. % or less, such as 0.5 wt. % or less, such as 0.4 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less. The aforementioned weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In one aspect, a gypsum panel, including any components thereof, formed in accordance with the present disclosure may have one or more magnetic fields (e.g., first magnetic field, second magnetic field, third magnetic field, etc.) generated and applied to the gypsum panel by one or more magnets at any time of the process disclosed herein, including at, before, and/or after any of the process steps disclosed herein. For instance, in one aspect, one or more magnetic fields may be generated and applied by one or more magnets after the gypsum slurry is provided or deposited onto a first facing material, before a second facing material is provided onto the gypsum slurry, and/or after a second facing material is provided onto the gypsum slurry.

The one or more magnets utilized to produce one or more magnetic fields may be located at various positions relative to the gypsum slurry. For instance, the one or more magnets may be positioned below the gypsum slurry (e.g., below a conveyor carrying the gypsum slurry and facing material(s)). In this respect, the one or more magnets may be placed relative to the first facing material. In another aspect, the one of more magnets may be positioned above the gypsum slurry (e.g., above a conveyor carrying the gypsum slurry and facing material(s)). In this respect, the one or more magnets may be placed relative to the second facing material. In yet another aspect, the one or more magnets may be positioned below the gypsum slurry and above the gypsum slurry.

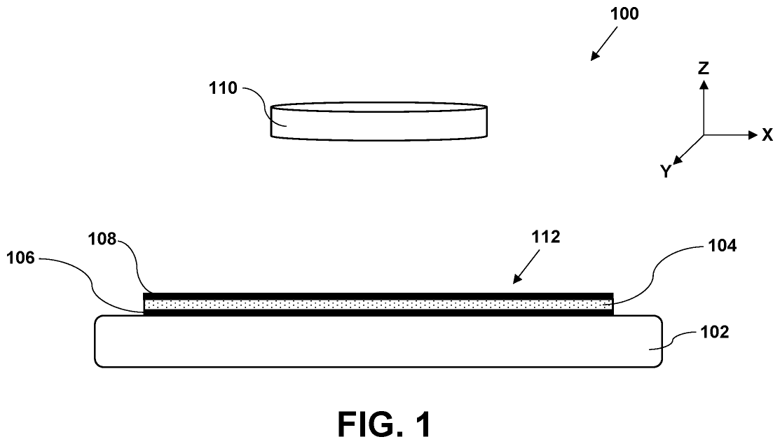

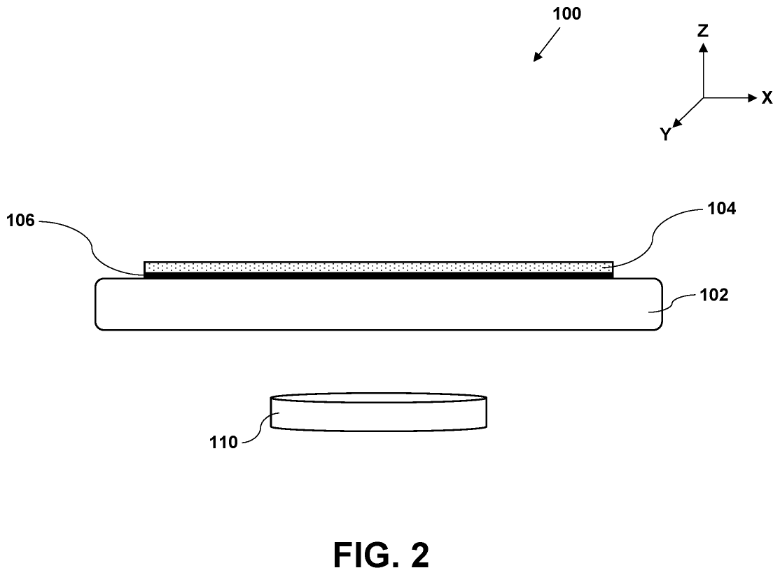

Generally, the one or more magnets may be positioned at one or more magnet position angles relative to the center of the outer surface of the first facing material (i.e., the center of the surface of the first facing material not adjacent to the gypsum slurry or gypsum core). The center of the outer surface of the first facing material is one dimensional and extends in the “y” direction, as illustrated in FIG. 1. The magnet position angle at which at least one of the one or more magnets is positioned is determined from the perspective of an observer viewing the first facing material moving in the machine direction (i.e., the first facing material is moving away from the observer), as illustrated in FIG. 1. As illustrated in FIG. 1, an exemplary system 100 for applying a magnetic field to a gypsum panel 112 is shown. The system 100 includes a conveyor assembly 102, such as a continuous belt or fabric. The system 100 of FIG. 1 further includes a gypsum slurry 104, a first facing material 106, a second facing material 108, and a magnet 110. In regard to the magnet position angle, one arm of the angle extends in the right, horizontal “x” direction and the other arm of the angle extends in the direction of the center of the respective magnet (e.g., center of mass, center of volume) of the one or more magnets 110. The vertex of these two arms of the magnet position angle is formed in the center of the outer surface of the first facing material 106. The magnet position angle is determined on the x-z plane, with “x” being a horizontal direction, “y” being the horizontal direction perpendicular to the “x” horizontal direction, and “z” being the vertical direction. For instance, as illustrated in FIG. 1, a magnet 110 positioned in the upward, vertical direction of the center of the outer surface of the first facing material 106 is at a 90° magnet position angle. Further, for instance, a magnet 110 positioned in the left, horizontal direction of the center of the outer surface of the first facing material 106 is at a 180° magnet position angle. Furthermore, for instance, as illustrated in FIG. 2, a magnet 110 positioned in the downward, vertical direction of the center of the outer surface of the first facing material 106 is at a 270° magnet position angle. As illustrated in FIG. 2, in one aspect, a magnet of the one or more magnets 110 may apply a magnetic field to a first facing material 106 before a second facing material 108 is provided or placed on the gypsum slurry. In another aspect, a magnet 110 may be positioned in the right, horizontal direction of the center of the outer surface of the first facing material 106, which is at a 0° magnet position angle.

In general, the one or more magnets may be placed at a magnet position angle of 0° or more, such as 20° or more, such as 40° or more, such as 80° or more, such as 120° or more, such as 160° or more, such as 200° or more, such as 240° or more, such as 280° or more, such as 320° or more, such as 359° or less, such as 320° or less, such as 280° or less, such as 240° or less, such as 200° or less, such as 160° or less, such as 120° or less, such as 80° or less, such as 40° or less, such as 20° or less, including all increments of 1° therebetween.

In general, the one or more magnets may be positioned at a selectively chosen magnet orientation position. In one aspect, a north pole of a magnet of the one or more magnets and a south pole of the same magnet of the one or more magnets may be positioned equidistant to the center of the outer surface of the first facing material. In another aspect, the north pole of a magnet of the one or more magnets may be positioned closer to the center of the outer surface of the first facing material when compared to the south pole of the same magnet of the one or more magnets. In yet another aspect, the south pole of a magnet of the one or more magnets may be positioned closer to the center of the outer surface of the first facing material when compared to the north pole of the same magnet of the one or more magnets.

In one aspect, the north pole and/or south pole of a magnet of the one or more magnets 110 may be positioned from about 0.1 inches to about 60 inches away from the center of the outer surface of the first facing material 106 of the gypsum panel 112 as determined by the x-z plane as illustrated in FIG. 1. Generally, the north pole and/or the south pole of a magnet of the one or more magnets may be positioned away from the center of the outer surface of the first facing material by about 1 inch or more, such as about 2 inches or more, such as about 6 inches or more, such as about 8 inches or more, such as about 10 inches or more, such as about 12 inches or more, such as about 16 inches or more, such as about 24 inches or more, such as about 36 inches or more, such as about 48 inches or more. In general, the north pole and/or the south pole of a magnet of the one or more magnets may be positioned away from the center of the outer surface of the first facing material by about 60 inches or less, such as about 48 inches or less, such as about 36 inches or less, such as about 24 inches or less, such as about 16 inches or less, such as about 12 inches or less, such as about 10 inches or less, such as about 8 inches or less, such as about 6 inches or less, such as about 2 inches or less, including all increments of 1 inch therebetween. In some aspects, a magnet of the one or more magnets may be located closer or further away from the center of the outer surface of the first facing material than the distances previously disclosed herein.

In general, the gypsum slurry may be subjected to one or more magnetic fields from the one or more magnets for a selectively chosen period of time. In this respect, an area or portion of a gypsum slurry, such as an area corresponding to the length of a gypsum panel (e.g., 8 feet, 9 feet, 10 feet, 12 feet, 14 feet, 16 feet) and the width of a gypsum panel (e.g., 4 feet) may be subjected to a magnetic field for a period of 0.01 seconds to about 0.2 seconds, including all increments of 0.01 seconds therebetween. For instance, an area or portion of gypsum slurry may be subjected to a magnetic field for a period of about 0.01 seconds or more, such as about 0.02 seconds or more, such as about 0.03 seconds or more, such as about 0.04 seconds or more, such as about 0.05 seconds or more, such as about 0.06 seconds or more, such as about 0.07 seconds or more, such as about 0.08 seconds or more, such as about 0.09 seconds or more, such as about 0.1 seconds or more. In general, an area or portion of gypsum slurry may be subjected to a magnetic field for a period of about 0.2 seconds or less, such as about 0.1 seconds or less, such as about 0.09 seconds or less, such as about 0.08 seconds or less, such as about 0.07 seconds or less, such as about 0.06 seconds or less, such as about 0.05 seconds or less, such as about 0.04 seconds or less, such as about 0.03 seconds or less, such as about 0.02 seconds or less. In one aspect, the aforementioned times may refer to the time a gypsum slurry is subject to a single magnet of the one or more magnets. In another aspect, the aforementioned times may refer to the time a gypsum slurry is subject to a plurality of magnets of the one or more magnets, such as all of the magnets of the one or more magnets. Furthermore, such time may be dictated by the speed of a continuous gypsum panel manufacturing line.

In one aspect, the weight ratio of water to stucco in the gypsum slurry may be selectively chosen. Notably, the fluidity of the gypsum slurry, which may be increased as the amount of water in the gypsum slurry is increased or as the amount of stucco in the gypsum slurry is decreased, may affect the movement or relocation of the one or more magnetic additives. In this respect, when a magnetic field is applied by one or more magnets, an increase in the water content of the gypsum slurry may result in an increase in the distance the one or more magnetic additives travel in the gypsum slurry. Further, when a magnetic field is applied by one or more magnets, an increase in the water content of a gypsum slurry containing one or more magnetic additives may result in an increase in the concentration of the one or more magnetic additives adjacent to or neighboring a respective facing material. Additionally, in one aspect, when a magnetic field is applied by one or more magnets, an increase in the water content of a gypsum slurry containing one or more magnetic additives may result in an increase in the embedment or penetration of the one or more magnetic additives and/or other gypsum slurry additives (e.g., stucco, water) in a respective facing material.

In general, the weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In one aspect, the strength of a magnet of the one or more magnets may be selectively chosen. Notably, the strength of a magnet of the one or more magnets may affect the distance of movement of one or more magnetic additives present in the gypsum slurry. In this respect, the strength of a magnet, as measured in gauss, of a magnet of the one or more magnets may be from about 100 gauss to about 12000 gauss, including all increments of 1 gauss therebetween. For instance, the strength of a magnet of the one or more magnets may be about 100 gauss or more, such as about 500 gauss or more, such as about 1000 gauss or more, such as about 2000 gauss or more, such as about 5000 gauss or more, such as about 10000 gauss or more. In general, the strength of a magnet of the one or more magnets may be about 12000 gauss or less, such as about 10000 gauss or less, such as about 5000 gauss or less, such as about 2000 gauss or less, such as about 1000 gauss or less, such as about 500 gauss or less.

Further, in one aspect, an area or portion of a gypsum slurry, such as an area corresponding to the length of a gypsum panel (e.g., 8 feet, 9 feet, 10 feet, 12 feet, 14 feet, 16 feet) and the width of a gypsum panel (e.g., 4 feet) may be subjected to a selectively chosen strength of a magnetic field produced by the one or more magnets. The strength of the magnetic field over the area of the gypsum slurry may be measured by a magnetometer. In one aspect, an area of a gypsum slurry may be subjected to a strength of a magnetic field of from about 100 gauss to about 12000 gauss, including all increments of 1 gauss therebetween. For instance, an area of a gypsum slurry may be subjected to a strength of a magnetic field of about 100 gauss or more, such as about 500 gauss or more, such as about 1000 gauss or more, such as about 2000 gauss or more, such as about 5000 gauss or more, such as about 10000 gauss or more. In general, an area of a gypsum slurry may be subjected to a strength of a magnetic field of about 12000 gauss or less, such as about 10000 gauss or less, such as about 5000 gauss or less, such as about 2000 gauss or less, such as about 1000 gauss or less, such as about 500 gauss or less.

Generally, the one or more magnets may comprise any material or component that the one or more magnetic additives may comprise as previously disclosed herein. For instance, the one or more magnets may comprise aluminum, barium, cobalt, copper, dysprosium, gadolinium, erbium, holmium, iron, magnesium, nickel, strontium, zinc, or a combination or alloy thereof. In general, the one or more magnets may be of any shape and size. For instance, the one or more magnets may include a horseshoe magnet, a bar magnet, a disc magnet, a spherical magnet (e.g., sphere magnet), a ring magnet, a donut magnet, a grate magnet, a cylinder magnet, or a combination thereof. In one aspect, the one or more magnets may include an Eriez magnet, such as an Xtreme® Rare Earth magnet. In one aspect, the one or more magnets may comprise one or more electromagnetic magnets.

In general, the one or more magnets may influence the positioning of the one or more magnetic additives in a gypsum slurry. For instance, one or more magnets may create one or more magnetic fields that may attract at least a portion of the one or more magnetic additives toward the one or more magnets. In this respect, the one or more magnets may influence the movement of at least a portion of the one or more magnetic additives such that at least a portion of the one or more magnetic additives move or relocate from their original position in the gypsum slurry to a position closer to the one or more magnets influencing the movement of the one or more magnetic additives. In some aspects, the one or more magnets may be positioned relative to a respective facing material. In this respect, the one or more magnets may affect the one or more magnetic additives such that at least a portion of the one or more magnetic additives move or relocate from their original position in the gypsum slurry to a position toward, closer to, and/or within one or more of the respective facing materials.

In general, after one or more magnets apply one or more magnetic fields to a gypsum slurry, the concentration of the one or more magnetic additives may be higher in the area of the gypsum slurry near or adjacent a respective facing material and may decrease across at least a portion of the thickness of the gypsum slurry. In one aspect, any of the respective gypsum core layers (e.g., first gypsum core layer, second gypsum core layer, third gypsum core layer) may have a higher concentration of the one or more magnetic additives compared to the other gypsum core layers. For instance, in one aspect, the first gypsum core layer and/or third gypsum core layer may have a higher concentration of the one or more magnetic additives than the second gypsum core layer.

In one aspect, the attraction of the one or more magnetic additives to the one or more magnets may result in the formation of a concentration gradient of the one or more magnetic additives in a gypsum slurry and gypsum core. For instance, after a magnet is placed or positioned below a gypsum slurry containing one or more magnetic additives, and a magnetic field is applied to the gypsum slurry, the concentration of the one or more magnetic additives in the gypsum slurry may be higher in the area of the gypsum slurry closest or adjacent to the first facing material and may be lower in the area of the gypsum slurry furthest away from the first facing material. In one aspect, a gypsum core formed in accordance with the present disclosure may have a higher concentration of the one or more magnetic additives adjacent to the first facing material with the concentration of the one or more magnetic additives decreasing across at least a portion of the thickness of the gypsum core. For instance, in one aspect, the concentration of the one or more magnetic additives in the gypsum slurry or gypsum core may decrease across at least a portion of the thickness of a gypsum slurry or gypsum core beginning at the portion of the gypsum slurry or gypsum core adjacent the first facing material and ending at the portion of the gypsum slurry or gypsum core adjacent the second facing material.

In another aspect, if a magnet is placed or positioned above a gypsum slurry containing one or more magnetic additives and a magnetic field is applied to the gypsum slurry, the concentration of the one or more magnetic additives in the gypsum slurry may be higher in the area of the gypsum slurry closest or adjacent to the second facing material and may be lower in the area of the gypsum slurry furthest away from the second facing material. In this respect, a gypsum core formed in accordance with the present disclosure may have a higher concentration of the one or more magnetic additives adjacent to the second facing material with the concentration of the one or more magnetic additives decreasing across at least a portion of the thickness of the gypsum core. For instance, in one aspect, the concentration of the one or more magnetic additives in the gypsum slurry or gypsum core may decrease across at least a portion of the thickness of a gypsum slurry or gypsum core beginning at the portion of the gypsum slurry or gypsum core adjacent the second facing material and ending at the portion of the gypsum slurry or gypsum core adjacent the first facing material.

In yet another aspect, if a magnet is placed or positioned above and below the gypsum slurry containing one or more magnetic additives, and a magnetic field is applied by the magnet above the gypsum slurry and the magnet below the gypsum slurry, the concentration of the one or more magnetic additives in the gypsum slurry may be higher in the area of the gypsum slurry closest or adjacent to the facing materials (e.g., first facing material, second facing material) and may decrease toward the center of the thickness of a gypsum slurry. In this respect, a gypsum core formed in accordance with the present disclosure may have a higher concentration of the one or more magnetic additives adjacent to the first facing material and the second facing material with the concentration of the one or more magnetic additives decreasing toward the center of the thickness of the gypsum core. It should be understood that the center of the thickness of the gypsum core is parallel to one or more respective facing materials and is a plane that extends the length and width of the gypsum core.

In one aspect, the ratio of the concentration of the one or more magnetic additives at the interface of the gypsum core and a facing material (e.g., the first facing material, the second facing material) to the concentration of the one or more magnetic additives at the center of the thickness of the gypsum core may be from about 20:1 to about 1:20, including all incremental ratios therebetween. For instance, the ratio of the concentration of the one or more magnetic additives at the interface of the gypsum core and a facing material (e.g., the first facing material, the second facing material) to the concentration of the one or more magnetic additives at the center of the thickness of the gypsum core may be 20:1 or less, such as about 15:1 or less, such as about 10:1 or less, such as about 5:1 or less, such as about 1:1 or less, such as about 1:5 or less, such as about 1:10 or less, such as about 1:15 or less. In general, the ratio of the concentration of the one or more magnetic additives at the interface of the gypsum core and a facing material (e.g., the first facing material, the second facing material) to the concentration of the one or more magnetic additives at the center of the thickness of the gypsum core may be about 1:20 or more, such as about 1:15 or more, such as about 1:10 or more, such as about 1:5 or more, such as about 1:1 or more, such as about 5:1 or more, such as about 10:1 or more, such as about 15:1 or more.

In one aspect, the attraction of the one or more magnetic additives to the one or more magnets may result in the embedment or penetration of one or more magnetic additives and/or other additives of a gypsum slurry (e.g., water, gypsum) in one or more of the facing materials, which may enhance the gypsum core to facing material bond and/or the water and air resistance of a gypsum panel. For instance, after a magnet is placed below a gypsum slurry containing one or more magnetic additives and a magnetic field is applied to the gypsum slurry, the one or more magnetic additives and/or other additives of the gypsum slurry may move or relocate to the first facing material and embed or penetrate into the first facing material. Notably, the embedment or penetration of the one or more magnetic additives in a respective facing material may block, obstruct, or otherwise prevent water and/or air from penetrating or infiltrating a respective facing material.

Generally, the one or more magnetic additives and/or the other additives of a gypsum slurry (e.g., water, gypsum) may penetrate at least a portion of the thickness of a respective facing material (e.g., first facing material, second facing material). For instance, the one or more magnetic additives and/or the other additives of a gypsum slurry (e.g., water, gypsum) may penetrate a respective facing material (e.g., first facing material, second facing material) by about 0%to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

In one aspect, the one or more magnetic additives may be influenced by the one or more magnets such that gypsum slurry or gypsum core additives (e.g., gypsum, one or more magnetic additives, starch, polymer) are pulled or carried to the interface of the gypsum slurry or gypsum core and a respective facing material. For instance, the migration or relocation of the one or more magnetic additives may pull or draw a starch (e.g., pregelatinized starch) or a polymer to the interface of the gypsum slurry or gypsum core and a respective facing material. In this respect, the starch or polymer may reinforce a respective facing material.

In another aspect, the one or more magnetic additives may be influenced by the one or more magnets such that the gypsum panel may have a magnetic utility layer. The magnetic utility layer may allow for the attaching of magnetic objects to the gypsum panel.

In yet another aspect, at least a portion of the one or more magnetic additives may be coated with a water-resistant material or a combination of water resistant materials (e.g., a wax, siloxane, silicone). In this respect, a magnet of the one or more magnets may attract at least a portion of the one or more magnetic additives comprising a water-resistant coating, which may enhance the air and water resistance of a gypsum panel.

Various types of gypsum panels (e.g., exterior gypsum sheathing) may comprise at least one glass mat facing material. In general, a glass mat facing material comprises small pin holes present in the glass mat facing material that permit water channeling within the glass mat facing material. As a result, air and water barrier sealants, which may be referred to as an AWB sealant, layer, or coating, are often utilized to encapsulate or coat glass mat facing materials to reduce, mitigate, or prevent the intrusion of air and/or water in the glass mat facing material. Notably, the inclusion of the one or more magnetic additives disclosed herein in a gypsum panel formed in accordance with the present disclosure may result in a gypsum panel having integrated water resistance. Notably, in one aspect, the one or more magnetic additives may reduce or prevent the intrusion of water and/or air through the pin holes of a glass mat facing material. As previously disclosed herein, the application of a magnetic field to a gypsum slurry may result in the movement or relocation of at least a portion of the one or more magnetic additives and/or other gypsum panel additives (e.g., gypsum). In this respect, the movement or relocation of the one or more magnetic additives and/or other gypsum panel additives (e.g., gypsum) may be such that the one or more magnetic additives and/or other gypsum panel additives (e.g., gypsum) reduce or prevent the intrusion of water and/or air through the pin holes of a glass mat facing material. Further, the movement or relocation of the one or more magnetic additives may result in the gypsum core may have fewer voids or penetration points at and/or beneath the first facing material, the second facing material, or both. In this respect, the movement or relocation of the one or more magnetic additives may result in the creation of an in situ dense layer (e.g, first gypsum core layer, third gypsum core layer) which may increase the air and water barrier and water resistance performance of a gypsum panel.

In one aspect, other gypsum slurry additives (e.g., gypsum) may reduce or prevent the intrusion of water through the pin holes of a glass mat facing material. For instance, other gypsum slurry additives, including any of the gypsum slurry components disclosed herein, may move or relocate with the one or more magnetic additives. In this respect, the one or more magnetic additives may further draw or pull other components or additives of the gypsum slurry into or toward the respective facing materials. Notably, the movement of the one or more magnetic additives through the gypsum core may increase the density, reduce the porosity, and/or increase the concentration of gypsum at the interface of the gypsum core and the first facing material, at the interface of the gypsum core and the second facing material, or both.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes one or more magnetic additives. In this regard, the method may include a step of also combining one or more magnetic additives with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may also include water. Water may be employed for fluidity and also for rehydration of the gypsum to allow for setting. The amount of water utilized is not necessarily limited by the present invention.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 80 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100°° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80°° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature than unmodified starch. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components and additives for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

In one embodiment, the gypsum core may include a first gypsum core layer and a second gypsum core layer. The first gypsum core layer may be between the first facing material (e.g., front of the panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material. Like the first gypsum core layer, the third gypsum core layer may also be a gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers may be a particularly suitable location for one or more magnetic additives. In one aspect, having an amount of one or more magnetic additives present in a respective gypsum core layer closest to a magnet of the one or more magnets may have enhanced efficacy in reducing or preventing water intrusion when compared to having a similar amount of one or more magnetic additives present in a respective gypsum core layer further from the magnet. Such enhanced efficacy may be a result of the location of the one or more magnetic additives relative to the location of one or more magnets. In this respect, the influence via the magnetic field of a magnet of the one or more magnets on one or more magnetic additives may be increased as the distance between the magnet of the one or more magnets to the one or more magnetic additives is decreased.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as one or more magnetic additives. Further, the first gypsum core layer, the second gypsum core layer, and/or the third gypsum core layer may contain an additive in an amount as previously indicated herein.

As indicated herein, the gypsum core can include one or more magnetic additives. In this regard, in one embodiment, the first gypsum core layer may include one or more of the magnetic additives disclosed herein. In another embodiment, the second gypsum core layer may include one or more of the magnetic additives as disclosed herein. In a further embodiment, the third gypsum core layer may include one or more of the magnetic additives as disclosed herein.

In an even further embodiment, the first gypsum core layer and the second gypsum core layer may include one or more of the magnetic additives as disclosed herein. In another further embodiment, the first gypsum core layer, the second gypsum core layer, and the third gypsum core layer may include one or more of the magnetic additives as disclosed herein. In yet another embodiment, the one or more magnetic additives may be included adjacent to the first facing material and/or second facing material.

Regardless of the above, one or more magnetic additives may be present in any combination of gypsum core layers. However, in one embodiment, it should be understood that one or two of the aforementioned gypsum core layers may not include a magnetic additive. In one aspect, one or more gypsum core layers may comprise the same magnetic additive. Further, in one aspect, the one or more gypsum core layers may comprise different magnetic additives. The different magnetic additives of the one or more gypsum core layers may be chosen such that it is advantageous to have a particular magnetic additive in one gypsum core layer and a different magnetic additive in another, different gypsum core layer.

The gypsum panel disclosed herein may have many applications. For instance, the gypsum panel may be used as a standalone panel in construction for the preparation of walls, ceilings, floors, exterior sheathing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 80 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about such as about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lbr or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Example 1

Gypsum patties were made which included a magnetic additive in the gypsum patty and a facing material (i.e., glass mat facing material) provided or placed on the gypsum patty. The magnetic additive was magnetite. As used herein, “bleed through” refers to the observable presence of gypsum patty components (e.g., gypsum, magnetite) on the side of the facing material opposite the side of the facing material adjacent the gypsum patty. Each gypsum patty measured 4 inches in length and 4 inches in width. A gypsum patty was formed by a process including adding water, stucco, and optionally magnetite in varying weight ratios. The amount of stucco used to form each gypsum patty was about 95 grams with the amount of water being varied to achieve the desired water to stucco ratio. The water to stucco weight ratios were 0.64, 0.70, 0.76, 0.80, 0.84, and 0.90. To prepare each respective gypsum patty, water and stucco were combined. Before mixing the water and stucco, the combination of water and stucco was allowed to sit and hydrate for one (1) minute. Then, the water and stucco were mixed for ten (10) seconds to form a gypsum patty. Next, a glass mat facing material was placed on the mixture. The glass mat facing material measured 4 inches in length and 4 inches in width. Then, the glass mat facing material was removed from the gypsum patty and weighed. The “Gypsum Patty Weight” of Tables 1 and 2 refers to the weight of the gypsum patty after the glass mat facing material was removed from the gypsum patty. The “Glass Mat Facing Material Weight” of Tables 1 and 2 refers to the weight of a glass mat facing material sample measuring 2 inches in length and 2 inches in width taken from the center of the 4 inches by 4 inches glass mat facing material after the glass mat facing material was removed from the gypsum patty. A sample of the glass mat facing material, measuring 2 inches in length and 2 inches in width, had an initial weight of 0.98 grams before being provided or placed on the gypsum patty. The “Percent Increase in Glass Mat Facing Material Weight” of Tables 1 and 2, refers to the percent difference in weight between 0.98 grams, which is the weight of a 2″ by 2″ sample of the glass mat facing material before being provided or placed on the gypsum patty, and the “Glass Mat Facing Material Weight”. For instance, to determine the “Percent Increase in Glass Mat Facing Material Weight” of Sample 2, the equation would be:

$$( \frac{1.14 g}{0.98 g} - 1 ) * 100 \% = 1 6.3 \%$$

The “Percent Increase vs. Control”, or wet bond, refers to the percent difference in weight between the “Glass Mat Facing Material Weight” in Table 1 and the “Glass Mat Facing Material Weight” of Table 2 at the respective water to stucco weight ratio. For instance, to determine the “Percent Increase vs. Control” of Sample 8, the equation would be:

$$( \frac{1.13 g}{1.14 g} - 1 ) * 100 \% = - 0.9 \%$$

The control gypsum patties of varying water to stucco weight ratios are displayed in Table 1. The control gypsum patties of Table 1 were formed by the same process and materials as the gypsum patties of Table 2, except that the control gypsum patties of Table 1 did not contain a magnetic additive.

TABLE 1

| | | | | | | | Percent |
|---|---|---|---|---|---|---|---|
| | | | | | | | Increase in |
| | | | | | | Glass Mat | Glass Mat |
| Gypsum | | | Amount of | | Gypsum | Facing | Facing |
| Patty | Water-Stucco | Amount of | Magnetic | Did Bleed | Patty | Material | Material |
| Sample | Ratio | Water | Additive | Through | Weight | Weight | Weight |
| Number | (Water/Stucco) | [cc] | [g] | Occur? | [g] | [g] | [%] |
| 1 | 0.64 | 60.8 | 0 | No | 97.99 | 1.26 | 28.6 |
| 2 | 0.70 | 66.5 | 0 | No | 94.69 | 1.14 | 16.3 |
| 3 | 0.76 | 72.2 | 0 | No | 90.99 | 1.17 | 19.4 |
| 4 | 0.80 | 76.0 | 0 | No | 91.61 | 1.21 | 23.5 |
| 5 | 0.84 | 79.8 | 0 | No | 87.57 | 1.20 | 22.4 |
| 6 | 0.90 | 85.5 | 0 | No | 85.60 | 1.20 | 22.4 |

TABLE 2

| | | | | | | | Percent | |
|---|---|---|---|---|---|---|---|---|
| | | | | | | | Increase in | |
| | | | | | | Glass Mat | Glass Mat | Percent |
| Gypsum | | | Amount of | Did | Gypsum | Facing | Facing | Increase |
| Patty | Water-Stucco | Amount of | Magnetic | Bleed | Patty | Material | Material | vs. |
| Sample | Ratio | Water | Additive | Through | Weight | Weight | Weight | Control |
| Number | (Water/Stucco) | [cc] | [g] | Occur? | [g] | [g] | [%] | [%] |
| 7 | 0.64 | 60.8 | 9.5 | No | 97.52 | 0.98 | 0.0 | −22.2 |
| 8 | 0.70 | 66.5 | 9.5 | No | 116.43 | 1.13 | 15.3 | −0.9 |
| 9 | 0.76 | 72.2 | 9.5 | No | 108.86 | 1.18 | 20.4 | 0.9 |
| 10 | 0.80 | 76.0 | 9.5 | No | 104.56 | 1.18 | 20.4 | −2.5 |
| 11 | 0.84 | 79.8 | 9.5 | No | 105.79 | 1.29 | 31.6 | 7.5 |
| 12 | 0.90 | 85.5 | 9.5 | No | 102.23 | 1.28 | 30.6 | 6.7 |

### Example 2

Gypsum patties were made which included a magnetic additive in the gypsum patty and a facing material (i.e., glass mat facing material) provided or placed on the gypsum patty. The magnetic additive was magnetite. As used herein, “bleed through” refers to the observable presence of gypsum patty components (e.g., gypsum, magnetite) on the side of the facing material opposite the side of the facing material adjacent the gypsum patty. Each gypsum patty measured 4 inches in length and 4 inches in width. A gypsum patty was formed by a process including adding water, stucco, and optionally magnetite in varying weight ratios. The amount of stucco used to form each gypsum patty was about 95 grams with the amount of water varying to achieve the desired water to stucco ratio. The water to stucco weight ratios were 0.64, 0.70, 0.76, 0.80, 0.84, and 0.90. To prepare each respective gypsum patty, water and stucco were combined. Before mixing the water and stucco, the combination of water and stucco was allowed to sit and hydrate for one (1) minute. Then, the water and stucco were mixed for ten (10) seconds to form a gypsum patty. Next, a glass mat facing material was placed on the mixture. The glass mat facing material measured 4 inches in length and 4 inches in width. Then, a magnet was placed above the gypsum patty, relative to the glass mat facing material. The magnet was applied for a period of 1 minute for the gypsum patties of Table 3 and Table 4. The magnet was applied for a period of 30 seconds for the gypsum patties of Table 5. Next, the glass mat facing material was removed from the gypsum patty and weighed. The “Gypsum Patty Weight” of Tables 4 and 5 refers to the weight of the gypsum patty after the glass mat facing material was removed from the gypsum patty. The “Glass Mat Facing Material Weight” of Tables 4 and 5 refers to the weight of a glass mat facing material sample measuring 2 inches in length and 2 inches in width taken from the center of the 4 inches by 4 inches glass mat facing material after the glass mat facing material was removed from the gypsum patty. A sample of the glass mat facing material, measuring 2 inches in length and 2 inches in width, had an initial weight of 0.98 grams before being provided or placed on the gypsum patty. The “Percent Increase in Glass Mat Facing Material Weight” of Tables 3, 4, and 5, refers to the percent difference in weight between 0.98 grams, which is the weight of a 2″ by 2″ sample of the glass mat facing material before being provided or placed on the gypsum patty, and the “Glass Mat Facing Material Weight”. For instance, to determine the “Percent Increase in Glass Mat Facing Material Weight” of Sample 13, the equation would be:

$$( \frac{1.08 g}{0.98 g} - 1 ) * 100 \% = 1 0.2 \%$$

The “Percent Increase vs. Control”, or wet bond, refers to the percent difference in weight between the “Glass Mat Facing Material Weight” in Table 3 and the “Glass Mat Facing Material Weight” of Table 4 and Table 5 respectively at the respective water to stucco weight ratio. For instance, to determine the “Percent Increase vs. Control” of Sample 19, the equation would be:

$$( \frac{1.11 g}{1.08 g} - 1 ) * 100 \% = 2.8 \%$$

The control gypsum patties of varying water to stucco weight ratios are displayed in Table 3. The control gypsum patties of Table 3 were formed by the same process and materials as the gypsum patties of Table 4 and Table 5, except that the control gypsum patties of Table 3 did not contain a magnetic additive.

TABLE 3

| | | | | | | | Percent |
|---|---|---|---|---|---|---|---|
| | | | | | | | Increase in |
| | | | | | | Glass Mat | Glass Mat |
| Gypsum | | | Amount of | | Gypsum | Facing | Facing |
| Patty | Water-Stucco | Amount of | Magnetic | Did Bleed | Patty | Material | Material |
| Sample | Ratio | Water | Additive | Through | Weight | Weight | Weight |
| Number | (Water/Stucco) | [cc] | [g] | Occur? | [g] | [g] | [%] |
| 13 | 0.64 | 60.8 | 0 | No | 99 | 1.08 | 10.2 |
| 14 | 0.70 | 66.5 | 0 | No | 104.82 | 1.12 | 14.3 |
| 15 | 0.76 | 72.2 | 0 | No | 95.35 | 1.16 | 18.4 |
| 16 | 0.80 | 76.0 | 0 | No | 95.62 | 1.17 | 19.4 |
| 17 | 0.84 | 79.8 | 0 | No | 93.57 | 1.20 | 22.4 |
| 18 | 0.90 | 85.5 | 0 | No | 88.60 | 1.17 | 19.4 |

TABLE 4

| | | | | | | | | Percent | |
|---|---|---|---|---|---|---|---|---|---|
| | | | | | | | | Increase in | |
| | | | | | Time Until | | Glass Mat | Glass Mat | Percent |
| Gypsum | | | Amount of | | Bleed | Gypsum | Facing | Facing | Increase |
| Patty | Water-Stucco | Amount of | Magnetic | Did Bleed | Through | Patty | Material | Material | vs. |
| Sample | Ratio | Water | Additive | Through | Occurred | Weight | Weight | Weight | Control |
| Number | (Water/Stucco) | [cc] | [g] | Occur? | [sec] | [g] | [g] | [%] | [%] |
| 19 | 0.64 | 60.8 | 9.5 | No | — | 105.23 | 1.11 | 13.3 | 2.8 |
| 20 | 0.70 | 66.5 | 9.5 | Yes | 33 | 118.18 | 1.46 | 49.0 | 30.4 |
| 21 | 0.76 | 72.2 | 9.5 | Yes | 28 | 114.25 | 1.62 | 65.3 | 39.7 |
| 22 | 0.80 | 76.0 | 9.5 | Yes | 29 | 112.51 | 1.66 | 69.4 | 41.9 |
| 23 | 0.84 | 79.8 | 9.5 | Yes | 19 | 106.88 | 1.81 | 84.7 | 50.8 |
| 24 | 0.90 | 85.5 | 9.5 | Yes | 12 | 103.14 | 1.61 | 64.3 | 37.6 |

TABLE 5

| | | | | | | | | Percent | |
|---|---|---|---|---|---|---|---|---|---|
| | | | | | | | | Increase in | |
| | | | | | Time Until | | Glass Mat | Glass Mat | Percent |
| Gypsum | | | Amount of | | Bleed | Gypsum | Facing | Facing | Increase |
| Patty | Water-Stucco | Amount of | Magnetic | Did Bleed | Through | Patty | Material | Material | vs. |
| Sample | Ratio | Water | Additive | Through | Occurred | Weight | Weight | Weight | Control |
| Number | (Water/Stucco) | [cc] | [g] | Occur? | [sec] | [g] | [g] | [%] | [%] |
| 25 | 0.64 | 60.8 | 9.5 | No | — | 112.99 | 1.22 | 24.5 | 13.0 |
| 26 | 0.70 | 66.5 | 9.5 | No | — | 110.44 | 1.37 | 39.8 | 22.3 |
| 27 | 0.76 | 72.2 | 9.5 | Yes | 22 | 108.27 | 1.45 | 48.0 | 25.0 |
| 28 | 0.80 | 76.0 | 9.5 | Yes | 14 | 111.37 | 1.56 | 59.2 | 33.3 |
| 29 | 0.84 | 79.8 | 9.5 | Yes | 12 | 106.29 | 1.75 | 78.6 | 45.8 |
| 30 | 0.90 | 85.5 | 9.5 | Yes | 20 | 107.12 | 1.79 | 82.7 | 53.0 |

### Example 3

Gypsum patties were made which included a magnetic additive in the gypsum patty and a facing material (i.e., glass mat facing material) provided or placed on the gypsum patty. The magnetic additive was magnetite. As used herein, “bleed through” refers to the observable presence of gypsum patty components (e.g., gypsum, magnetite) on the side of the facing material opposite the side of the facing material adjacent the gypsum patty. Each gypsum patty measured 4 inches in length and 4 inches in width. A gypsum patty was formed by a process including adding water, stucco, and optionally magnetite. The amount of stucco used to form each gypsum patty was about 95 grams with the amount of water being 76 cubic centimeters. The water to stucco weight ratio was 0.80 for all samples. To prepare each respective gypsum patty, water and stucco were combined. Before mixing the water and stucco, the combination of water and stucco was allowed to sit and hydrate for one (1) minute. Then, the water and stucco were mixed for ten (10) seconds to form a gypsum patty. Next, a glass mat facing material was placed on the mixture. The glass mat facing material measured 4 inches in length and 4 inches in width. Then, a magnet was placed above the gypsum patty, relative to the glass mat facing material. The magnet was applied for a period of 1 minute for all samples. Next, the glass mat facing material was removed from the gypsum patty and weighed. The “Gypsum Patty Weight” of Tables 6, 7, and 8 refers to the weight of the gypsum patty after the glass mat facing material was removed from the gypsum patty. The “Glass Mat Facing Material Weight” of Tables 6, 7, and 8 refers to the weight of a glass mat facing material sample measuring 2 inches in length and 2 inches in width taken from the center of the 4 inches by 4 inches glass mat facing material after the glass mat facing material was removed from the gypsum patty. A sample of the glass mat facing material, measuring 2 inches in length and 2 inches in width, had an initial weight of 1.11 grams before being provided or placed on the gypsum patty. The “Percent Increase in Glass Mat Facing Material Weight” of Tables 6, 7, and 8, refers to the percent difference in weight between 1.11 grams, which is the weight of a 2″ by 2″ sample of the glass mat facing material before being provided or placed on the gypsum patty, and the “Glass Mat Facing Material Weight”. For instance, to determine the “Percent Increase in Glass Mat Facing Material Weight” of Sample 32, the equation would be:

$$( \frac{1.27 g}{1.11 g} - 1 ) * 100 \% = 1 4.4 \%$$

The “Percent Increase vs. Control”, or wet bond, refers to the percent difference in weight between the “Glass Mat Facing Material Weight” of the control samples of Table 6 (i.e., sample 31), Table 7 (i.e., sample 37), and Table 8 (i.e., sample 43) and the “Glass Mat Facing Material Weight” of Tables 6, 7, and 8 at the respective amount of magnetite added. For instance, to determine the “Percent Increase vs. Control” of Sample 32, the equation would be:

$$( \frac{1.27 g}{1.32 g} - 1 ) * 100 \% = - 3.8 \%$$

The control gypsum patties of Tables 6, 7, and 8, which are samples 31, 37, and 43 respectively, contain no magnetic additives and were otherwise formed by the same process and materials as the gypsum patties containing a magnetic additive. The magnetite used in the samples of Table 6 had a D₅₀ of about 16. The magnetite used in the samples of Table 7 had a D₅₀ of about 20. The magnetite used in the samples of Table 8 had a D₅₀ of about 76.

TABLE 6

| | | | | | | | Percent | | Glass Mat |
|---|---|---|---|---|---|---|---|---|---|
| | | | | | | | Increase in | | Facing |
| | | | | Time Until | | Glass Mat | Glass Mat | Percent | Material |
| Gypsum | Amount of | Concentration | | Bleed | Gypsum | Facing | Facing | Increase | Weight |
| Patty | Magnetic | of Magnetic | Did Bleed | Through | Patty | Material | Material | vs. | After |
| Sample | Additive | Additive | Through | Occurred | Weight | Weight | Weight | Control | Drying |
| Number | [g] | [%] | Occur? | [sec] | [g] | [g] | [%] | [%] | [g] |
| 31 | 0 | 0 | No | — | 94.61 | 1.32 | 18.9 | 0.0 | 1.31 |
| (Control) | | | | | | | | | |
| 32 | 0.95 | 1 | No | — | 91.77 | 1.27 | 14.4 | −3.8 | 1.26 |
| 33 | 2.85 | 3 | No | — | 91.91 | 1.31 | 18.0 | −0.8 | 1.28 |
| 34 | 4.75 | 5 | No | — | 98.53 | 1.46 | 31.5 | 10.6 | 1.44 |
| 35 | 7.6 | 8 | Yes | 31 | 102.53 | 1.70 | 53.2 | 28.8 | 1.68 |
| 36 | 9.5 | 10 | Yes | 27 | 103.2 | 1.70 | 53.2 | 28.8 | 1.70 |

TABLE 7

| | | | | | | | Percent | | Glass Mat |
|---|---|---|---|---|---|---|---|---|---|
| | | | | | | | Increase in | | Facing |
| | | | | Time Until | | Glass Mat | Glass Mat | Percent | Material |
| Gypsum | Amount of | Concentration | | Bleed | Gypsum | Facing | Facing | Increase | Weight |
| Patty | Magnetic | of Magnetic | Did Bleed | Through | Patty | Material | Material | vs. | After |
| Sample | Additive | Additive | Through | Occurred | Weight | Weight | Weight | Control | Drying |
| Number | [g] | [%] | Occur? | [sec] | [g] | [g] | [%] | [%] | [g] |
| 37 | 0 | 0 | No | — | 94.48 | 1.33 | 19.8 | 0.0 | 1.31 |
| (Control) | | | | | | | | | |
| 38 | 0.95 | 1 | No | — | 99.13 | 1.28 | 15.3 | −3.8 | 1.26 |
| 39 | 2.85 | 3 | No | — | 104.13 | 1.29 | 16.2 | −3.0 | 1.28 |
| 40 | 4.75 | 5 | No | — | 102.00 | 1.43 | 28.8 | 7.5 | 1.41 |
| 41 | 7.6 | 8 | Yes | 14 | 105.36 | 1.65 | 48.6 | 24.1 | 1.65 |
| 42 | 9.5 | 10 | Yes | 12 | 111.45 | 1.73 | 55.9 | 30.1 | 1.72 |

TABLE 8

| | | | | | | | Percent | | Glass Mat |
|---|---|---|---|---|---|---|---|---|---|
| | | | | | | | Increase in | | Facing |
| | | | | Time Until | | Glass Mat | Glass Mat | Percent | Material |
| Gypsum | Amount of | Concentration | | Bleed | Gypsum | Facing | Facing | Increase | Weight |
| Patty | Magnetic | of Magnetic | Did Bleed | Through | Patty | Material | Material | vs. | After |
| Sample | Additive | Additive | Through | Occurred | Weight | Weight | Weight | Control | Drying |
| Number | [g] | [%] | Occur? | [sec] | [g] | [g] | [%] | [%] | [g] |
| 43 | 0 | 0 | No | — | 94.31 | 1.24 | 11.7 | 0.0 | 1.23 |
| (Control) | | | | | | | | | |
| 44 | 0.95 | 1 | Yes | 32 | 104.14 | 1.37 | 23.4 | 10.5 | 1.36 |
| 45 | 2.85 | 3 | No | — | 100.28 | 1.44 | 29.7 | 16.1 | 1.42 |
| 46 | 4.75 | 5 | No | — | 101.13 | 1.95 | 75.7 | 57.3 | 1.89 |
| 47 | 7.6 | 8 | Yes | 40 | 103.31 | 1.75 | 57.7 | 41.1 | 1.74 |
| 48 | 9.5 | 10 | No | — | 107.54 | 1.69 | 52.3 | 36.3 | 1.68 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core comprising gypsum and one or more magnetic additives and having a concentration gradient of the one or more magnetic additives over a portion of the thickness of the gypsum core; and
a first facing material and a second facing material, the first facing material and the second facing material sandwiching the gypsum core.

2. The gypsum panel of claim 1, wherein the one or more magnetic additives comprise magnetite.

3. The gypsum panel of claim 1, wherein the one or more magnetic additives has a D₅₀ of about 1 micron to about 100 microns.

4. The gypsum panel of claim 1, wherein the one or more magnetic additives are present in the gypsum panel in an amount of about 0.01 wt. % to about 2 wt. % based on the weight of the gypsum panel.

5. The gypsum panel of claim 1, wherein the concentration gradient of the one or more magnetic additives decreases across the thickness of the gypsum core, the thickness of the gypsum core beginning at a portion of the gypsum core adjacent the first facing material and ending at the portion of the gypsum core adjacent the second facing material.

6. The gypsum panel of claim 1, wherein the gypsum core comprises a first gypsum core layer and a second gypsum core layer, wherein the first gypsum core layer has a higher concentration of the one or more magnetic additives than the second gypsum core layer.

7. The gypsum panel of claim 6, wherein the gypsum core comprises a third gypsum core layer

8. A gypsum panel comprising:
a gypsum core comprising gypsum and one or more magnetic additives; and
a first facing material and a second facing material, the first facing material and the second facing material sandwiching the gypsum core, wherein at least a portion of the one or more magnetic additives penetrates a portion of the thickness of the first facing material, the second facing material, or both.

9. The gypsum panel of claim 8, wherein the one or more magnetic additives comprises magnetite.

10. The gypsum panel of claim 8, wherein the one or more magnetic additives has a D₅₀ of about 1 micron to about 100 microns.

11. The gypsum panel of claim 8, wherein the one or more magnetic additives are present in the gypsum panel in an amount of about 0.01 wt. % to about 2 wt. % based on the weight of the gypsum panel.

12. The gypsum panel of claim 8, wherein at least a portion of the one or more magnetic additives penetrates at least a portion of the thickness of the first facing material.

13. The gypsum panel of claim 8, wherein at least a portion of the one or more magnetic additives penetrates at least a portion of the thickness of the second facing material.

14. A method for making a gypsum panel comprising:
providing a first facing material;
depositing a gypsum slurry comprising stucco, water, and one or more magnetic additives onto the first facing material;
providing a second facing material on the gypsum slurry; and
allowing the stucco to convert to calcium sulfate dihydrate
wherein the method further comprises generating at least one magnetic field with one or more magnets before providing the second facing material on the gypsum slurry and/or after the step of providing the second facing material on the gypsum slurry, the at least one magnetic field moving at least a portion of the one or more magnetic additives in the gypsum slurry toward the first facing material, the second facing material, or both.

15. The method of claim 14, wherein the method further comprises generating a magnetic field with one or more magnets before providing the second facing material on the gypsum slurry.

16. The method of claim 14, wherein the method further comprises generating a magnetic field with one or more magnets after the step of providing the second facing material on the gypsum slurry.

17. A system for forming a gypsum panel containing one or more magnetic additives:
one or more magnets;
a conveyor assembly; and
a gypsum slurry comprising one or more magnetic additives.

18. The system of claim 17, wherein the one or more magnetic fields relocate at least a portion of the one or more magnetic additives.

19. The system of claim 17, wherein the one or more magnetic fields relocate at least a portion of the one or more magnetic additives toward a first facing material, a second facing material, or both.

20. The system of claim 17, wherein at least one magnet of the one or more magnets has a magnet position angle of 90°.

21. The system of claim 17, wherein at least one magnet of the one or more magnets has a magnet position angle of 180°.
